(19) United States
(12) Patent Application Publication
(10) Pub. No.: US 2003/0071100 A1
(43) Pub. Date: Apr. 17, 2003

(54) Multiple roll and boxed goods dispenser

(76) Inventor: Joseph W. Miller, Manchester, MO (US)

Correspondence Address: JOSEPH W. MILLER, 16 TIMBERLEIGH CT, MANCHESTER, MO, 63021, US

(21) Appl. No.: 10/270,898

(22) Filed: Oct. 15, 2002

Related U.S. Application Data
(60) Provisional application No. 60/329,272, filed on Oct. 15, 2001.

(51) Int. Cl. B26F 3/02

(52) U.S. Cl. 225/38

(57) ABSTRACT

A dispenser for locating beneath a wall cabinet or shelf and provided for dispensing sheet materials, or boxed material, such as sheets, or bags. The dispenser includes a pair of support beams, one normally for locating the front, and the other at the back, and a pivotal door connecting to the front beam. The space between the beams are compartmentalized, and end walls provide closure to the dispenser. The various compartments are provided for mounting miscellaneous rolls or boxes of dispensed material. One or more styles of clamps connect to one or both of the beams, and can hold, for example, a roll of paper towels, while other compartments include lower flanges, for support of the rolls or boxed material, for dispensing. Various types of roll holding devices, such as shaped wire, are resilient and flexible members are designed for holding rolls of the sheet materials in place, during dispensing. The dispenser may be reversed, to locate the rolled dispensing material, such as towels, at either end of the dispenser. A shaped wire, or thin flexible member, may extend from one beam of the dispenser, for engagement within the bottom of a box, for holding the box of material during dispensing, or the device may be used in a drawer, to hold boxed goods therein for dispensing.

### BACKGROUND OF THE INVENTION

The present invention relates to new and useful improvements in dispensers for household roll products such as plastic wrap, foil, wax paper, paper towels, and boxed goods such as sandwich bags, freezer bags, and trash bags, etc.

In the U.S. Pat. No. 5,129,565 issued Jul. 14, 1992, to Joseph W. Miller, the inventor in this application, there is disclosed a dispenser cabinet for organizing and dispensing one or more sheet materials, such as described above. Dispensing compartments are formed by horizontally spaced vertical panels attached to a pair of support beams. A roll compartment comprises a cantilevered shelf which supports the roll, a dispensing slit formed by the space between the edge of the cantilevered shelf an its adjacent vertical panel, and a cutting edge located on the bottom of said panel. A box compartment is defined by the space between any two said panels and a cantilevered shelf does not require a cutting edge. A paper towel holding means is attached to the end of the support beams and above the plane of the smaller rolls and their respective compartments. A door attaches to one of the said beams enclosing the dispensing compartments when said dispenser is attached to an existing wall cabinet.

The manufacture of the prior dispensing cabinet is relatively expensive and uneconomical to manufacture with the visible paper towel holding means as disclosed. The said dispenser has a design feature that requires right or left hand tearing when employed in one of its more useful embodiments. The present invention requires the manufacture of both left and right tear models as the invention as disclosed does not permit reversibility, that is, the manufacture of a single model that could be used either as a right or left tear as determined by the consumer. Furthermore, while the consumer has no objection to paper towel holders that visibly expose the paper towels, when given the choice to conceal the paper towel behind a door like the other wrap products, the consumer prefers the concealed look. The prior dispenser did not address this consumer preference and the resulting effects on the dispenser.

Another disadvantage of said dispenser is the cantilevered bottom shelf. This is an extra element that adds weight and costs to the overall invention that may not be required. Furthermore, the attachment of the bottom panel by the cantilevered design requires additional strength for the vertical side panels. Thus, by the elimination of the bottom panels further reduction of material and weight can be eliminated from the side panels.

Another disadvantage of the bottom panels as used in the invention to support rolls, occurs with the reduction of weight as the sheet materials are spent. The frictional forces that are employed by the rolls are dependent on weight and that decreases as the roll is spent. The tearing and dispensing of the roll is dependent on these frictional forces and becomes more difficult as the roll is more than fifty percent spent.

The increased use of boxed goods also provides consumers with more choices and more storage and dispensing requirements for these goods. The unmovable and fixed box holding means limits the number of models that can be offered economically and impacts negatively on the commercial success of the invention. Thus, the present invention is concerned with one or more improvements in such a dispenser.

### BRIEF DESCRIPTION OF THE DRAWINGS

FIG. 1 is a perspective view of a preferred embodiment with the paper towel in a separate compartment and concealed behind the dispenser door.

FIG. 1a is a perspective view of a preferred embodiment shown with the paper towel in a separate compartment as in FIG. 1, and the door open to allow loading and removal of the rolls, and visual inspection.

FIG. 2 is a perspective view of another preferred embodiment of the invention shown with thin flexible roll holding means for the rolls of paper, foil, wax, and plastic.

FIG. 2a is a perspective view of FIG. 2 shown with the front door open to allow loading and removal of rolls, and visual inspection.

FIG. 3 is a perspective view of an embodiment of the invention shown with removable and reversible roll holding means with adjustable tensioning means, and a removable reversible box holding means.

FIG. 3a is a top view of FIG. 3 and shown with the door closed.

FIG. 3b is a perspective of a thin flexible embodiment of a box holding means.

FIG. 3c is a side view of the box holding means of FIG. 3b holding a box in one of the preferred embodiments.

FIG. 4 is a rear view of the removable roll holding means showing the flexible and adjustable tensioning means on a phantom roll core.

FIG. 5 is a perspective view of a thin flexible box holding means for receiving several boxes and attached to the inside surface of a cabinet door.

### SUMMARY OF THE INVENTION

Accordingly, besides the advantages of the existing prior art, several objects and advantages of the present invention are:

to provide a multi roll household goods cabinet dispenser that provides for concealing the paper towel behind the dispensed door;

to provide a dispenser with a removable reversible paper towel holding means that provides adjustable tension control;

to provide a dispenser with a removable reversible roll holding means that provides adjustable tension control and eliminates the need for a roll support shelf;

to provide a one piece molded dispenser with a fixed roll holding means that provides for reversibility, tension control, and a manual stop or breaking feature;

to provide a dispenser with a removable reversible box holding means that eliminates the need for a box compartment and box shelf; and

to provide a dispenser that can provide a plurality of roll-box configurations.

Further objects and advantages are to provide a new method of dispensing boxed goods such as sandwich bags, freezer bags, trash bags, etc., such that they may be dispensed directly from an existing object such as a kitchen drawer, cabinet door, whereby the box is held by relatively thin and flexible holding means between the means and the folds of the box. Additional boxed wrap dispensers may be possible due to invention of this box holding means.

### DESCRIPTION OF THE PREFERRED EMBODIMENT

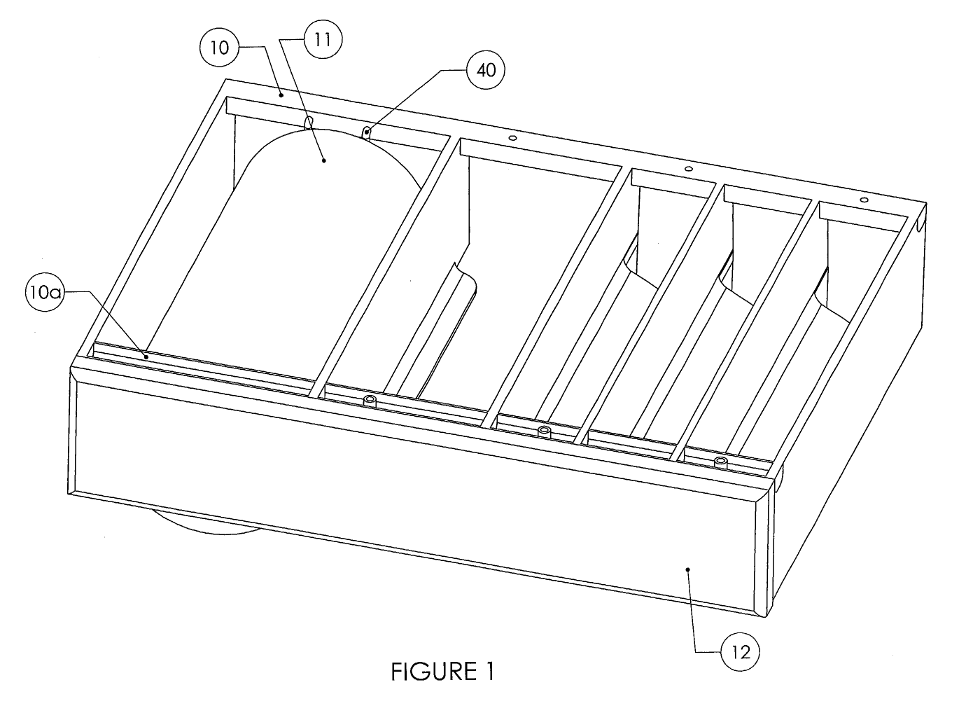

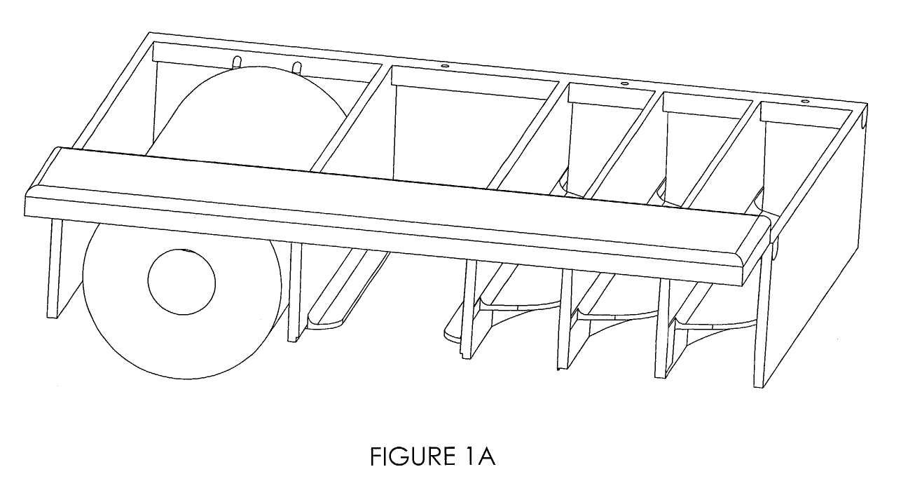

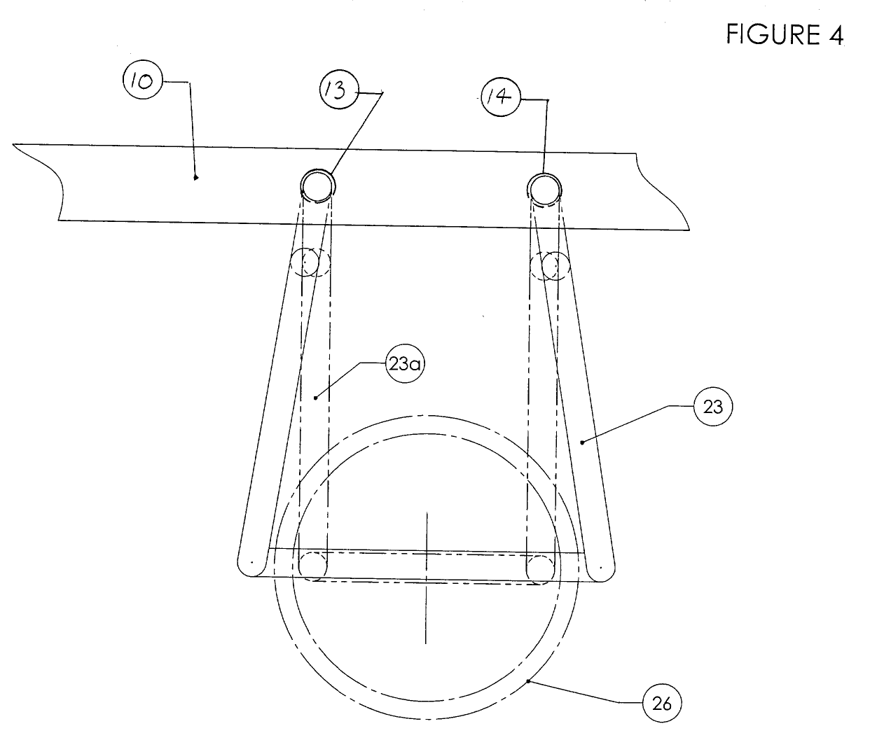

According to one aspect of the present invention, as shown in FIG. 1, FIG. 1a, the paper towel roll 11 is located below the two support beams 10 and 10a, such that it may be enclosed by the dispenser door 12. A removable and reversible holding means 40 is provided for holding the paper towel between two horizontally spaced vertical side panels. The holding means 23, as shown in FIG. 4, supportably holds the roll from the inside of the core 26 on which the roll is wound and provides adjustable tensioning forces against the core. In one embodiment of the holding means, a 3/16″ diameter steel wire is formed such that end forms an elongated U or tongue, for receiving core 26, the other ends are inserted into holes 13. 14 provided in beams 10, 10a, or by a clip that can be attached to one of said beams for the purpose of receiving the holding means. By spacing the receiving holes wider than the distance of said ends of the wire, tension forces are applied for hoding the core. The tension forces are visually shown by the compression of the wire 23 to 23a, whereby the wire 23 represents the holding means before the core 26 has been inserted onto the said means, and the 23a after the core 26 has been inserted. The holding means also comprises two perpendicular bends or changes in elevation and allows additional flexibility for core diameter variations and consumer adjustments. The holding means is readily removable and attachable to either of the beams 10 and 10a, which contain receiving holes allowing the general public to choose and reverse the dispenser tearing action. In this embodiment, the paper towel is easily inserted onto the tongue from the front of the dispenser. The holding means allows the paper towels to be dispensed independently of the door being opened or closed.

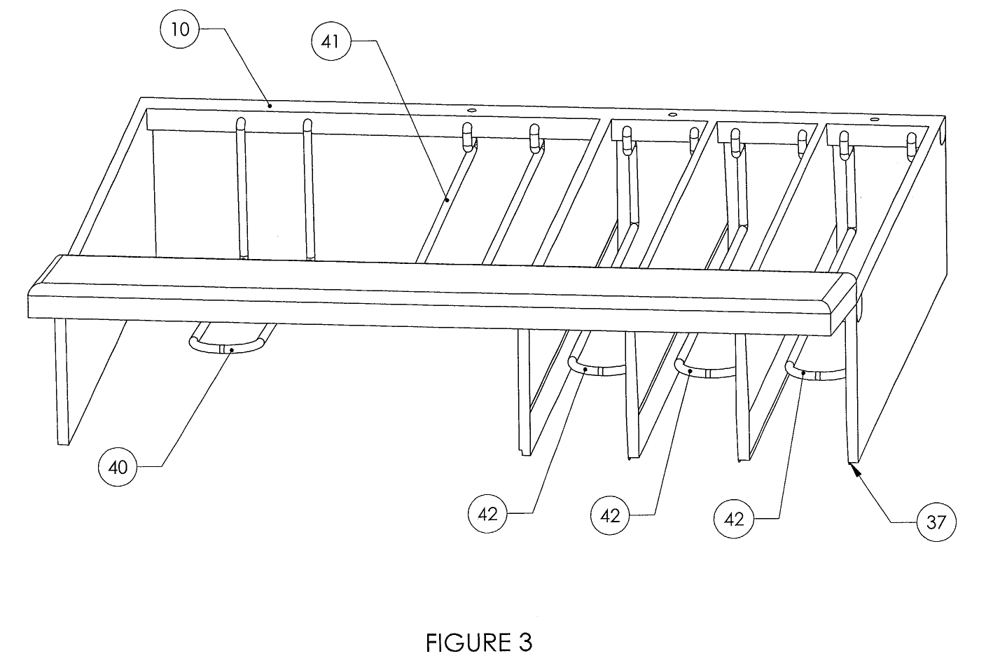

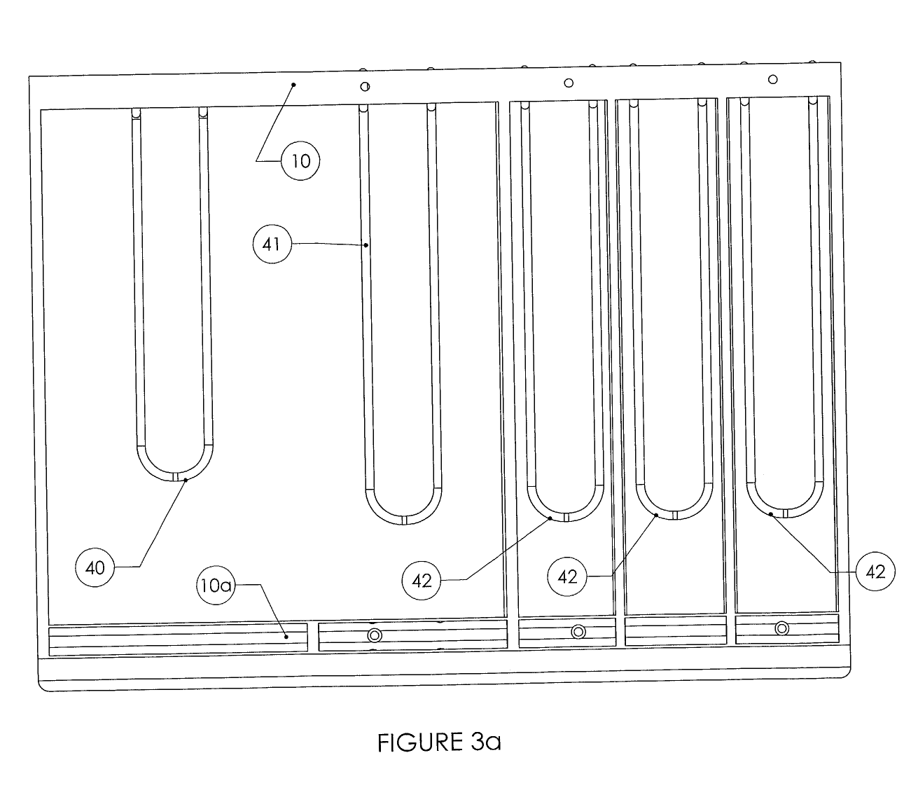

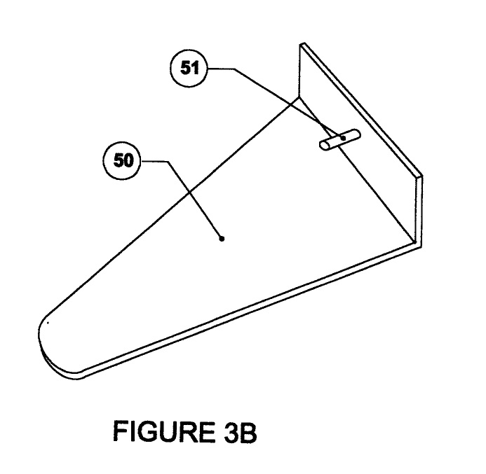

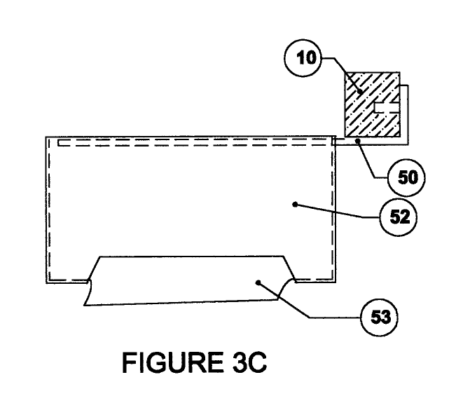

FIGS. 3 and 3a show another embodiment of the invention employing a removable reversible holding means 42 for the smaller rolls of plastic (saran), foil, and wax papers. The roll holding means eliminates the necessity of bottom panels in the prior art, reducing the size and weight of the said panels, and provides additional features as a reversibility and tension control.

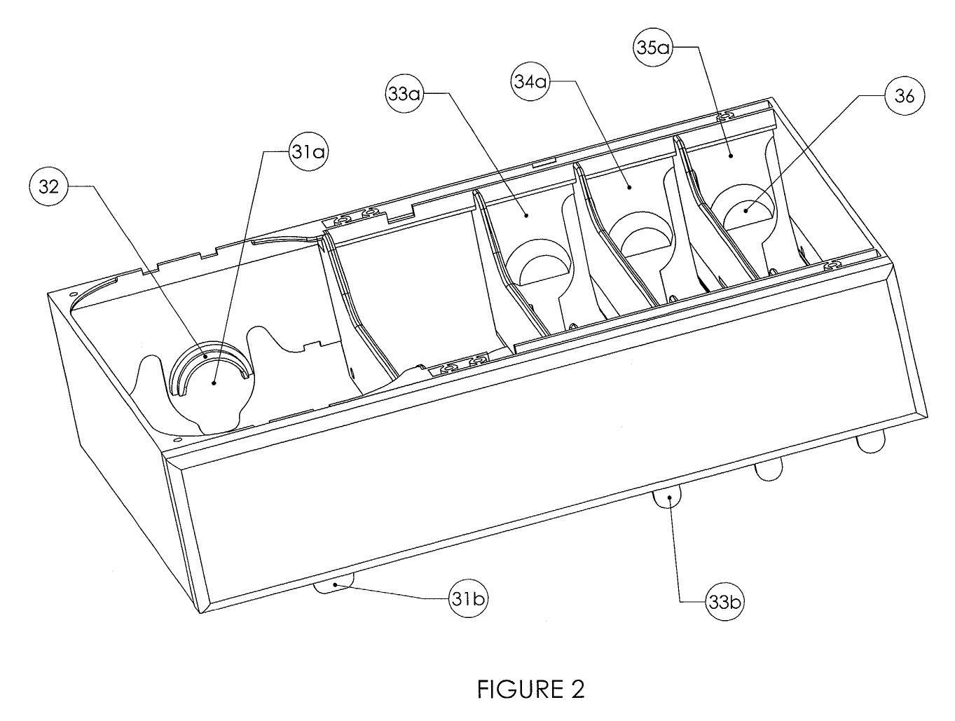

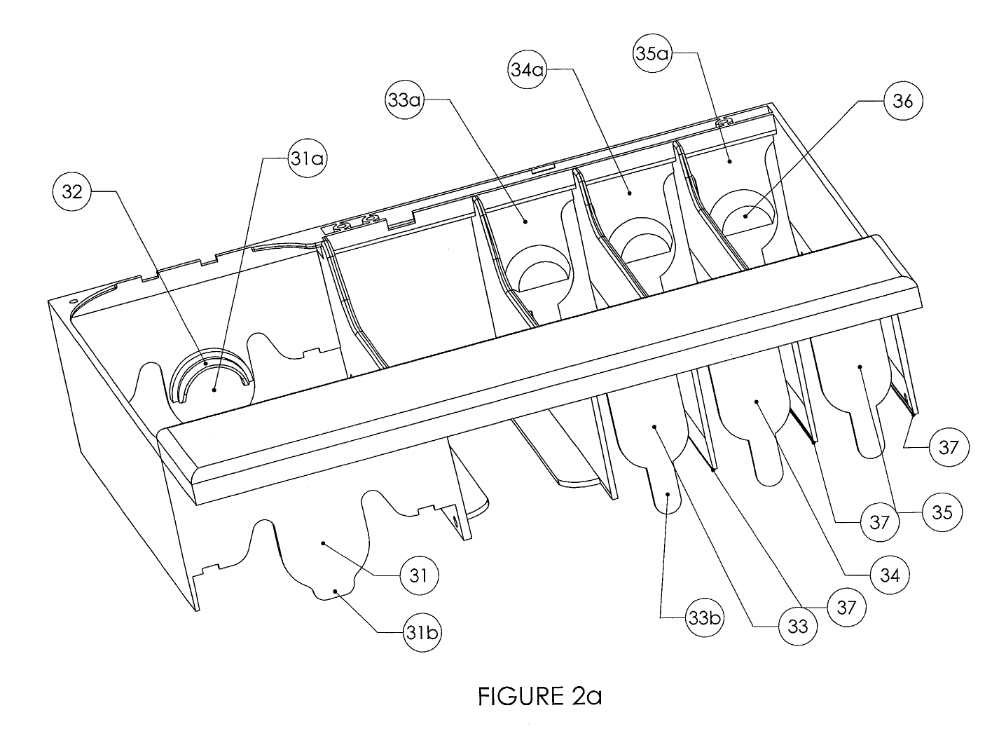

FIGS. 2 and 2a show another embodiment of the invention that is suitable and may provide increased advantages for one piece injection molding. In such a case, it is desirable to have a fixed unmovable roll holding means that will still allow reversibility and tension control. Such an embodiment comprises thin, flexible members, supportably attached to said beams and containing tapered apertures for receiving the roll core. Flexible members 31 and 31a are provided with a tapered aperture 32 for holding a paper towel roll. Flexible members 33, 33a through 35, and 35a are provided with a tapered aperture 36, for holding and receiving the rolls of plastic, wax, and foil. The flexible members provide for a small tab 33b that extends down below the door to provide a manual means for removing the core when the dispenser door is opened. The tab is also used as a manual break that holds the roll during tearing operations when the roll is nearly spent or if the flexible members are insufficient to provide tension. Various surface finishes may be applied to the tapered aperture 32 and 36, as known in the art to affect the roll frictional forces.

To further improve the said invention, a new and improved box holding means is employed. The box holding means is both reversible and removable and adds further to the commercialization of the dispenser. The prior art provided a compartment comprising panel and bottom plates. The new box holding means secures a box of rolled goods for dispensing, by employing an interference and frictional fit between said means and the folds of said box, or between the means and an internal side of the box. While some boxes are folded to allow insertion of a holding means, others may require cutting or slitting an opening to receive said means. This novel means for holding and dispensing boxed goods eliminates the need for a compartment and all the various elements and costs associated with it. The holding means in and by itself provides many new and useful features for the invention, but in combination with the improved roll holding means described above, the multi-roll, multi-box dispenser is truly unique. The invention, as currently employed in Commerce, requires two models, yet offers consumers the choice of four variations of the roll/box configurations.

FIGS. 3 and 3a show one embodiment of a box holding means 41, attached to the beam 10 of one of the preferred embodiments. The holding means 41 consists of 3/16″ diameter steel wire formed in a loop or elongated U for receiving the “fold” of a standard box of rolled goods, the other two ends of the holder are attached to the receiving holes in beam 10.

FIG. 3b shows another embodiment of the box holding means in which a thin flexible element 50 shaped lie a tongue, and having a cylindrical rod 51 for attaching to a support beam 10 of the invention. As shown in FIG. 3c, a box 52 is inserted onto the elongated U portion of the thin flexible element 50 or the wire element 41, between the folds of the cardboard box in such the manner as to allow the dispensing of the boxed goods 53 in a manner similar to dispensing “Kleenex” tissues. The new holding means securely holds the box in any position such that the goods can be readily dispensed. In combination with the removable roll holding means of said invention, a single large compartment comprising sufficient space to hold a standard roll of paper towels and a single box of goods held in place by the removable box holding means, can be easily converted to a compartment for holding three boxed goods. This improvement requires the addition of an extra box holding means and the addition of two receiving holes in said members. The additional versatility and consumer choices versus the extra little cost of the wire holding means provides an enormous commercial benefit and advantage over prior art.

In another embodiment of the box holding means, an additional stiffening element may be provided lengthwise on the strip by impressing a V shape channel or grooves onto the flat strip.

Since consumers use a wide variety of boxed goods, the holding means is likely to comprise of several thin flexible strip elements attached commonly to a base or frame. When employing an embodiment of this nature to the present invention, three flexible strip elements may be employed and removably attached to support beams 10 and 10a. In combination with the removable reversible paper towel roll holding means 40, a compartment of the invention is capable of holding and dispensing one roll of towels and one boxed good, or by removing the roll holding means, three boxed goods holding means would also be available for the consumer without additional costs. The thin flexible box holding means would lie flat above the paper towel roll if the consumer would rather use the space for paper towels instead of boxed goods. By changing or adding compartments, many other useful combinations of rolls and boxed goods are available.

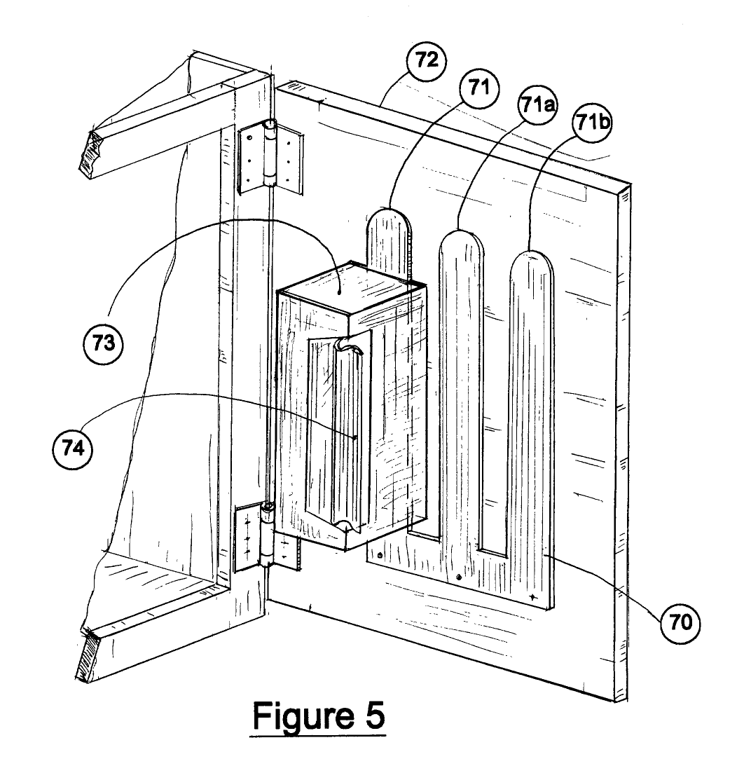

FIG. 5 shows another embodiment of a box holding means employing three thin flexible elements 71, 71a, and 71b, commonly joined from a single base 70 and attached to a single vertical surface such as the back side (inside) of a cabinet door 72. A box 73 is supportably held in place against the door 72 by the flexible element 71 which inherently resists the bending forces applied to it when the boxed goods 74 is dispensed from the box 73. In a further embodiment, the holding means could be fastened to the bottom of a standard kitchen drawer. The consumer would only have to pull the drawer out, and the boxed goods would be held securely and neatly in place with the opened end up, conveniently ready to be dispensed. Unlike wire compartments, whereby a variety of boxed goods are stored, the box holding means would not require any appreciable space when not being used to hold a box.

The box holding means should not be considered limited to household boxed goods, but should prove useful for the dispensing of a wide range of materials from their original boxes as used today in commerce. Other household applications include gift wraps, and also other roll products such as foil, plastic, and wax paper. Currently, the rolls packaged in boxes are not provided with an open top or dispensing slots, but the novelty of a new holding means is disclosed herein may provide the stimulus for a new class of boxes and/or dispensing apparatus.

I claim:

1. A sheet material dispenser for locating beneath a wall cabinet or shelf and unmovably supporting and dispensing multiple rolls of sheet materials comprising:
a. an attachment means for securing said dispenser beneath a cabinet or shelf comprising a plurality of support members;
b. compartments for receiving the sheet materials comprising horizontally spaced, vertical side panels, supportably attached transversely to said support members, a bottom panel cantilevered from each of said panels and extending toward one adjacent said panel and defining a longitudinal dispensing slot, said compartment is substantially aligned in a horizontal plane so as to substantially align the respective rolled sheets materials in a horizontal plane;
c. a cutting means for separating a portion of the sheet material comprising a serrated edge, supportably attached to the bottom edge of said panel;
d. a removable reversible paper towel roll holding means in combination with an adjustable tension means;
e. a door for removing and replacing the rolled sheet materials, wherein said door is placed vertically and perpendicular to said panels, thereby forming a front end panel for restricting the axial motion of the roll materials during a tearing and dispensing operation.

2. A multiple roll dispenser of claim 1, wherein said holding means comprises a rod shape to form a loop or elongated U at one end for receiving said roll, and the two opposite ends attaching to said support members via receiving holes in said support members, and formed to provide a vertical distance below said support members, said receiving holes spaced slightly wider than said opposing ends such that holding means tapers outwardly from said loop to said support, thereby providing a tensioned fit when said roll with a core is inserted on to said rod.

3. A multiple roll dispenser of claim 1, wherein the cutting edges lie in a plane that is inclined with respect to a horizontal plane so as to facilitate the dispensing operation.

4. A multiple roll dispenser of claim 1, wherein at least one of said compartments is suitable for receiving boxed sheet materials such as sandwich bags.

5. A multiple roll dispenser of claim 1, which is substantially made from wood.

6. A sheet material dispenser for locating beneath a cabinet or shelf and unmovably supporting and dispensing a plurality of rolled sheet material comprising;
a. an attachment means for securing said dispenser beneath a cabinet comprising a plurality of horizontal support members;
b. compartments for receiving the sheet material comprising horizontally spaced, vertical said panels, supportably attached transversely to said horizontal support members, a bottom side panel cantilevered from each of said panels and defining a longitudinal dispensing slot, said compartments are substantially aligned in a horizontal plane so as to substantially align the respective rolled sheet materials in a horizontal plane, and end panel that restricts the axial movement of the sheet materials.
c. a cutting means for separating a portion of the sheet material comprising a serrated cutting edge, supportably attached or made part of bottom said panels.
d. a removable reversible paper towel holding means in combination with an adjustable tension control means;
e. a door for removing and replacing the rolled sheet materials wherein said door is placed vertically and perpendicular to said panels, thereby forming another end panel of the dispenser.

7. A multiple roll dispenser of claim 6, wherein the cutting edge lie in a plane that is inclined with respect to a horizontal plane so as to facilitate the dispensing operation.

8. A multiple roll dispenser of claim 6, wherein at least one of said compartments is suitable for receiving boxed sheet materials.

9. A multiple roll dispenser of claim 6, whereby one of said end panels is continuous with a door of said cabinet.

10. A sheet material and household goods dispenser for locating beneath a wall cabinet of shelf and removably supporting and dispensing multiple rolls of household wraps and boxed goods comprising;
a. an attachment means for securing said dispenser beneath a cabinet comprising a plurality of horizontal support member;
b. compartments for receiving the rolled sheet materials and boxed materials comprising horizontally spaced vertical side panels;
c. a box holding means;
d. a removable and reversible roll holding means in combination with an adjustable tensioning means whereby rolls are held by the core between two said panels;
e. a cutting means for separating a portion of the sheet material comprising of a serrated edge supportably attached to the bottom of said panels or made part of bottom said panels;
f. a door for removing and replacing the rolled sheet materials and boxed good wherein said door is placed vertically and perpendicular to said panels thereby forming a front end panel of said dispenser.

11. A multiple roll dispenser of claim 10, wherein said roll holding means comprises a rod shape to form a loop or an elongated U at one end for receiving said roll, and the two opposing ends attaching to said support members via receiving holes in said support members, and formed to provide a vertical distance below said support members, said receiving holes spaced slightly wider than said opposing ends such that holding means tapers outwardly from said loop to said support, thereby providing tensioned fit when said roll with a core is inserted onto said rod.

12. A dispenser of claim 10, whereby said box holding means comprises a bottom shelf supportably attached to one of said panels, whereby shelf supports the box.

13. A dispenser of claim 10, whereby only rolled sheet materials are housed and dispensed.

14. A dispenser of claim 10, whereby only boxed materials are housed and dispensed.

15. A dispenser of claim 10, whereby said roll holding means is fixed and comprises tapered cylindrical apertures for receiving the roll core, supportably attached to very thin and flexible members supportably attached to said support members.

16. A dispenser of claim 10, whereby said box holding means is removable and reversible whereby said means securely holds the box by employing an interference and friction fit between the folds of the box and the said means.

17. A dispenser of claim 15, whereby said holding means also comprises an extension of the flexible member beyond the door so as to provide a manual breaking action on a roll during a dispensing operation.

18. A dispenser of claim 16, whereby said box holding means comprises a wire or rod of spring steel, formed to form a tongue or loop for receiving and inserting in to the folds of a cardboard box, the other ends insert into receiving holes on said support members, or said ends attached to another member for attachment to the said support members.

19. A dispenser of claim 16, whereby said box holding means comprises a thin flexible strip, or a plurality of strips, forming a tongue at one end for insertion into the folds of a folded box, the other end attached to frame or base whereby it is held for securing boxes for dispensing.

20. A dispenser of claim 10, whereby said door of said dispenser is continuous with a door of said cabinet.

21. A box dispenser comprising of a box holding means, in combination with the attachment means for securing said dispenser to the surface of any desirable and suitable object for the intention of dispensing box contents, whereby said holding means securely holds a folded box by employing an interference and frictional fit between the folds of said box and the said means.

22. A dispenser of claim 21, whereby the holding means is removable for allowing loading and removing of boxes.

23. A dispenser of claim 21, whereby the holding means comprises a thin flexible rod shape to receive a fold of said box.

24. A dispenser of claim 21, whereby the holding means comprises a thin flexible strip formed to receive a fold of said box.
